(19) United States
(12) Patent Application Publication
(10) Pub. No.: US 2025/0097621 A1
(43) Pub. Date: Mar. 20, 2025

(54) LISTENING APPARATUS, CONTROL METHOD OF LISTENING APPARATUS, AND NON-TRANSITORY COMPUTER READABLE MEDIUM

(71) Applicant: JVCKENWOOD Corporation, Yokohama-shi (JP)

(72) Inventors: Toru KAIWA, Yokohama-shi (JP); Masashi UEMOTO, Yokohama-shi (JP); Takayuki UCHIDA, Yokohama-shi (JP); Nobuyuki HOTTA, Yokohama-shi (JP); Makoto ORYOJI, Yokohama-shi (JP); Takao AOKI, Yokohama-shi (JP)

(21) Appl. No.: 18/959,534

(22) Filed: Nov. 25, 2024

Related U.S. Application Data
(63) Continuation of application No. PCT/JP2023/014187, filed on Apr. 6, 2023.

(30) Foreign Application Priority Data
May 31, 2022 (JP) 2022-088903

(51) Int. Cl. H04R 1/10

(52) U.S. Cl. CPC H04R 1/1041; H04R 1/1091; H04R 2420/07; H04R 2460/01

(57) ABSTRACT

On/off of a wireless function of a listening apparatus is automatically controlled. A listening apparatus according to a present embodiment is a listening apparatus that is of a type worn on an ear and that includes at least one of a noise cancelling processing unit and a collected sound processing unit, the listening apparatus including a wireless communication unit configured to be connected to a wireless device, the wireless communication unit being capable of receiving an audio signal from the wireless device, an ear-worn detection unit configured to detect whether the listening apparatus is worn on an ear or not, and a control processing unit configured to turn off the wireless communication unit in a case where it is detected that the listening apparatus is worn on an ear before the wireless communication unit is connected to the wireless device.

### CROSS REFERENCE TO RELATED APPLICATION

This application is based upon and claims the benefit of priority from International Patent Application No. PCT/JP2023/014187, filed on Apr. 6, 2023, which is based on Japanese Patent Application No. 2022-088903, filed on May 31, 2022, the disclosure of which is incorporated herein in its entirety by reference.

### BACKGROUND

The present invention relates to a listening apparatus, a control method of the listening apparatus, and a program.

Japanese Unexamined Patent Application Publication No. 2000-182310 discloses a technology according to which a temperature sensor, an infrared sensor or the like is provided on headphones, and whether the headphones are worn or not is determined based on a sensor output, and if the headphones are not worn, power saving control is performed by reducing volume or pausing a playback operation, for example.

Some listening apparatuses such as headphones and earphones include a noise cancellation function of reducing noise generated in surroundings of a user, and a sound collection function of performing an amplification process and the like on sound that is collected, so that sound around a user can be easily heard. Furthermore, some listening apparatuses include a wireless function of wirelessly connecting to a wireless device such as a smartphone, and of receiving an audio signal from an information terminal. When power of such a listening apparatus is turned on, not only the noise cancellation function and the sound collection function, but also the wireless function is turned on.

The wireless function is turned on even if a user wants to use only the noise cancellation function and the sound collection function of the listening apparatus, and thus battery is consumed more than necessary. To use the noise cancellation function and the sound collection function while turning off only the wireless function, a user has to perform an additional operation. Moreover, a connection process to a wireless device is automatically performed at the time of activation (turning on of power) of the listening apparatus, and thus an operation for turning off the wireless function is performed after waiting for connection.

In a state where a reconnection destination is not found or a pairing destination is being searched for, when a predetermined period of time passes, power of the listening apparatus itself is turned off, and it is not possible to continuously use the listening apparatus by itself. Furthermore, in a case where the noise cancellation function or the sound collection function is used in a connection standby state where the wireless function is turned on, there is a risk of being connected by a third party. To reduce battery consumption and erroneous connection to another device, it is desired to turn off the wireless function without an additional operation, and to use the noise cancellation function and the sound collection function.

### SUMMARY

A listening apparatus according to an aspect is a listening apparatus of a type worn on an ear, including at least one of a noise cancelling processing unit and a collected sound processing unit, the listening apparatus including: a wireless communication unit configured to be connected to a wireless device, the wireless communication unit being capable of receiving an audio signal from the wireless device; an ear-worn detection unit configured to detect whether the listening apparatus is worn on an ear or not; and a control processing unit configured to turn off the wireless communication unit in a case where it is detected that the listening apparatus is worn on an ear before the wireless communication unit is connected to the wireless device.

A control method of a listening apparatus according to an aspect is a control method of a listening apparatus that is of a type worn on an ear and that includes at least one of a noise cancelling processing unit and a collected sound processing unit, the control method including: a step of connecting a wireless communication unit of the listening apparatus to a wireless device so that an audio signal from the wireless device can be received; and a step of detecting whether the listening apparatus is worn on an ear or not; and including a step of turning off the wireless communication unit in a case where it is detected that the listening apparatus is worn on an ear before the listening apparatus is connected to the wireless device.

### BRIEF DESCRIPTION OF THE DRAWINGS

The above and other aspects, advantages and features will be more apparent from the following description of certain embodiments taken in conjunction with the accompanying drawings, in which:

FIG. 1 is a functional block diagram showing a configuration of a listening apparatus according to an embodiment;

FIG. 2 is a flowchart for describing a control method of a listening apparatus according to a first embodiment;

FIG. 3A is a flowchart for describing a control method of a listening apparatus according to a second embodiment;

FIG. 3B is a flowchart for describing the control method of the listening apparatus according to the second embodiment;

FIG. 4A is a flowchart for describing a control method of a listening apparatus according to a third embodiment;

FIG. 4B is a flowchart for describing the control method of the listening apparatus according to the third embodiment;

FIG. 5 is a flowchart for describing a modified example of the control method of the listening apparatus according to the first embodiment; and

FIG. 6 is a flowchart for describing a modified example of the control method of the listening apparatus according to the second embodiment.

### DETAILED DESCRIPTION

Hereinafter, embodiments will be described with reference to the drawings. However, the present disclosure is not limited to the following embodiments. Moreover, for the sake of clarity of description, the following description and drawings are simplified as appropriate.

An embodiment relates to a listening apparatus that is wirelessly connected to a wireless device, and that is capable of outputting an audio signal from the wireless device. The listening apparatus is an acoustic device that can be worn on an ear of a user, and typically includes an output unit for a right ear and a left ear. The listening apparatus may be overhead headphones including a head band, or may be earphones such as canal or inner-ear earphones. The listening apparatus may be left-right separated (complete wireless type) earphones where left and right output units are separated from each other. Moreover, the listening apparatus may be left-right integrated earphones such as neck-band type earphones where the left and right output units are connected to each other. Of course, the listening apparatus is not limited to the examples given above.

The listening apparatus is connected to a wireless device by wireless communication by Bluetooth (registered trademark) or the like. The listening apparatus includes a speaker, a microphone and the like disposed outside a housing forming the output unit. For example, the wireless device is a smartphone, a tablet terminal or the like including a music playback function. Additionally, the wireless device is not limited to a smartphone and the like, and may be an IC recorder, a music player, or the like.

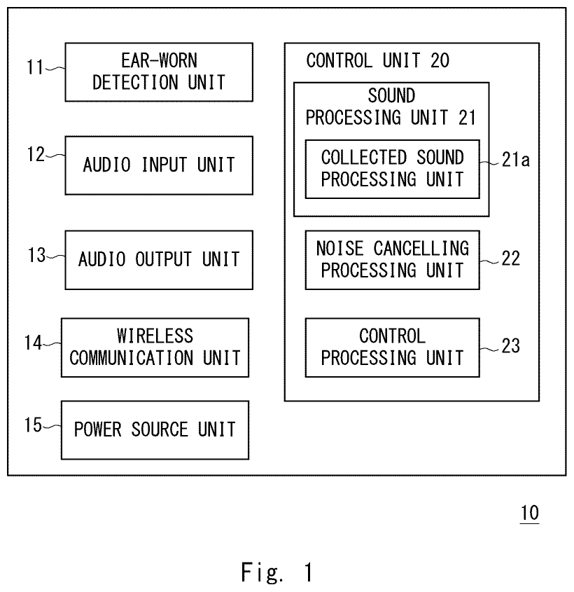

FIG. 1 is a functional block diagram showing a configuration of the listening apparatus according to the embodiment. As shown in FIG. 1, a listening apparatus 10 includes an ear-worn detection unit 11, an audio input unit 12, an audio output unit 13, a wireless communication unit 14, and a control unit 20. The control unit 20 includes a sound processing unit 21, a noise cancelling processing unit 22, and a control processing unit 23.

The ear-worn detection unit 11 detects whether a user wore the listening apparatus 10 on an ear or not. For example, as the ear-worn detection unit 11, an infrared sensor for detecting infrared rays emitted from the user, a temperature sensor for detecting a body temperature of the user, or the like is used. For example, the ear-worn detection unit 11 may be arranged at a position that faces the user when the listening apparatus 10 is worn by the user. The ear-worn detection unit 11 outputs, to the control unit 20, a detection signal indicating that the listening apparatus 10 is worn by the user.

The audio input unit 12 is a device that acquires a collected sound as an audio signal. For example, a microphone is used as the audio input unit 12. A sound that is collected by the audio input unit 12 is a voice of a person with whom the user is having a conversation, or an ambient sound including a noise that is generated around the user, for example. The audio input unit 12 is arranged facing outside the housing, or in other words, facing in an opposite direction from a head of the user, for example. The sound collected by the audio input unit 12 is converted into an audio signal, and is then transmitted to the control unit 20.

In a worn state, the audio output unit 13 outputs a sound that is based on an audio signal from a wireless device that is connected, or an audio signal corresponding to sound collected by the audio input unit 12. The “sound” here is not limited to an audible sound, a frequency or a sound pressure level of which is in an audible range, but may also include an inaudible sound, a frequency or a sound pressure level of which is outside the audible range.

The wireless communication unit 14 is a communication interface based on short-range wireless communication standards such as Bluetooth, Wi-Fi (registered trademark), or infrared communication, and is a module for communication with a wireless device. Additionally, an example will be described below where transmission/reception is performed by a communication interface compatible with Bluetooth standards, but any short-range wireless communication may be used.

A wireless device includes a wireless communication unit, not shown, for wirelessly transmitting/receiving data to/from the listening apparatus 10. The wireless communication unit of the wireless device is based on the same wireless communication standards as the listening apparatus 10 described above. A paired state is achieved when the listening apparatus 10 and a wireless device existing within a communication range exchange identification information such as Bluetooth address and perform mutual authentication. Information about the wireless device that is paired and registered is stored in a storage unit, not shown. The wireless communication unit 14 is capable of receiving an audio signal from the wireless device that is connected through successful pairing.

Additionally, the wireless device may include a display unit configured by a display device such as a liquid crystal panel, and a touch panel including an input unit configured by an operation detection device, such as a touch screen, and the like (neither is shown). A user may input data, issue an instruction regarding an operation, and so on, by touching the touch panel with a finger or the like. Furthermore, a user may activate an application program installed in a smartphone, and make various settings regarding the listening apparatus 10.

Furthermore, a power source unit 15 is embedded in the listening apparatus. For example, the power source unit 15 is a secondary battery, and supplies power that is necessary for operation of the listening apparatus 10. Because the power source unit 15 is embedded in the listening apparatus 10, the listening apparatus 10 is capable of operating wirelessly. In the case where a secondary battery is used, power can be supplied from an external battery charger via a terminal (not shown) provided in the housing.

The sound processing unit 21 performs various processes for acquiring an audio signal, and for outputting a sound based on the audio signal from the left and right output units. The sound processing unit 21 includes a collected sound processing unit 21a. The collected sound processing unit 21a achieves a sound collection function of a sound collector by performing predetermined audio processing such as frequency processing and amplification processing on sound that is collected by the audio input unit 12. The noise cancelling processing unit 22 generates, as a cancellation signal, a signal that is obtained by performing phase reversal on an ambient sound collected by the audio input unit 12. The control unit 20 can cancel noise from outside by adding the cancellation signal to the audio signal and outputting the same from the audio output unit 13. That is, the noise cancelling processing unit 22 achieves a noise cancellation function of reducing noise that is generated around the user. Additionally, in the example shown in FIG. 1, the listening apparatus 10 includes both the sound collection function and the noise cancellation function, but the listening apparatus 10 may instead include one of the functions.

The control processing unit 23 controls on/off of a communication function of the wireless communication unit 14 for the wireless device, based on a detection signal from the ear-worn detection unit 11. More specifically, when it is detected that the listening apparatus 10 is worn on an ear before the wireless communication unit 14 is connected to the wireless device, the control processing unit 23 turns off the wireless communication unit 14. A control method of the listening apparatus 10 by the control processing unit 23 will be described later in detail.

As components that are not shown, the listening apparatus 10 includes a processor, a memory, and a storage apparatus. The storage apparatus stores a program for causing a computer to perform a process of each structural element of the listening apparatus 10. The processor causes a program to be loaded into the memory from the storage apparatus, and executes the program. The processor thus achieves each function of the control unit 20.

Alternatively, each structural element of the listening apparatus 10 may be implemented by dedicated hardware. Moreover, each structural element may be partially or entirely implemented by a combination of general-purpose or dedicated circuits or the like. Each structural element may be partially or entirely implemented by a combination of a circuit or the like mentioned above and a program. As the processor, a central processing unit (CPU), a graphics processing unit (GPU), a field-programmable gate array (FPGA), or the like may be used.

A program includes a set of instructions (or software codes) for causing, when loaded into a computer, the computer to perform one or more functions described in the embodiment. The program may be stored in a non-transitory computer-readable medium or a tangible storage medium. By way of example, and not a limitation, computer-readable media or tangible storage media include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and a magnetic cassette, a magnetic tape, a magnetic disk storage or other types of magnetic storage devices. The program may be transmitted on a transitory computer-readable medium or a communication medium. By way of example, and not a limitation, transitory computer-readable media or communication media include electrical, optical, acoustical, or other forms of propagated signals.

Additionally, the listening apparatus 10 may include an operation button (not shown) that allows setting of various operations. The listening apparatus 10 performs an assigned operation according to pressing of the operation button. For example, switching between on and off of power, on and off of the noise cancellation function, on and off of the sound collection function, and the like may be performed according to the number of times of pressing of the operation button, a position that is pressed, a pressing direction, or the like.

The operation button may be provided on one or both of the left and right output units. In the case where only one operation button is provided on a left-right separated listening apparatus, information about an operation performed on the operation button provided on one output unit may be transferred to the other output unit. In the case where the operation button is provided on each of the left and right output units, different operations may be assigned to the operation buttons to be performed by the listening apparatus 10. Furthermore, switching between on and off of power, a function or the like may be performed independently between the left and right output units.

The operation button may be a physical operation button, a touch sensor, which is a virtual operation button, or the like. Furthermore, the listening apparatus 10 may include a component for receiving an operation through audio input.

As described above, with a wireless listening apparatus including the noise cancellation function and the sound collection function, when power is turned on, not only the noise cancellation function and the sound collection function, but also the wireless function is turned on. In the embodiment, in the case where the user wants to use only the noise cancellation function and the sound collection function of the listening apparatus, the wireless function is automatically turned off without an additional operation. In the following, a control method of the listening apparatus 10 will be described. In the following description, earphones will be described as an example of the listening apparatus 10.

### First Embodiment

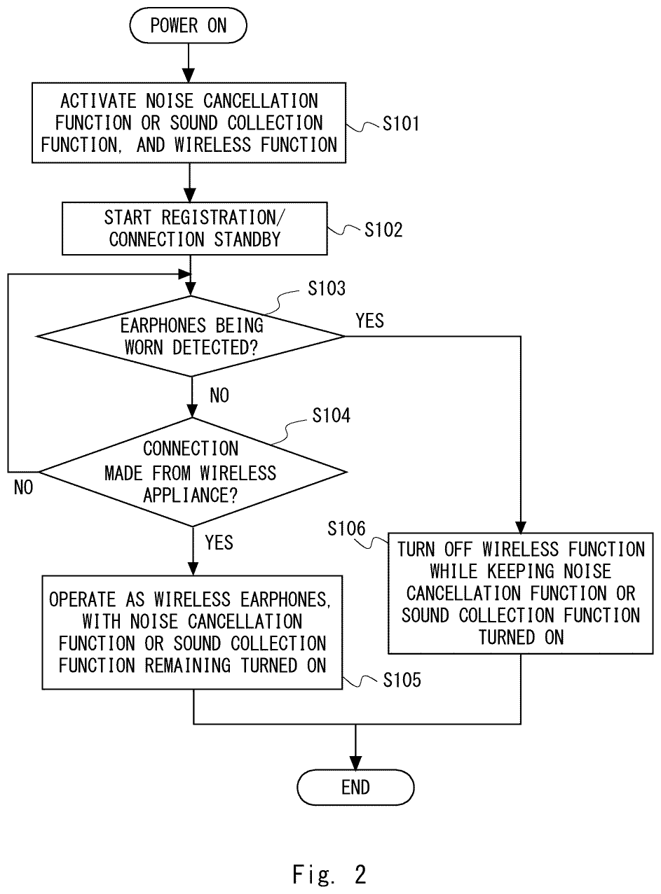

FIG. 2 is a flowchart for describing a control method of a listening apparatus according to a first embodiment. The first embodiment is an example of a control method of left-right integrated wireless earphones. The flowchart in FIG. 2 indicates an example where on/off of the wireless function is controlled in a state where the earphones are in a pairing mode in which registration standby is performed in relation to an unregistered wireless device. As shown in FIG. 2, when power of the earphones is turned on, the noise cancellation function or the sound collection function, and the wireless function are activated (S101), and registration/connection standby is started in relation to an unregistered wireless device (S102).

Then, whether it is detected or not that the earphones are worn is determined (S103). In the case where it is detected that the earphones are worn (S103: YES), the control processing unit 23 turns off the wireless function while keeping the noise cancellation function or the sound collection function turned on (S106). On the other hand, in the case where it is not detected that the earphones are worn (S103: NO), whether connection is made from a wireless device or not is determined (S104). That connection is made from a wireless device means that identification information or the like is transmitted from the wireless device to the listening apparatus 10, and pairing is established such that communication is enabled, for example. In the case where connection is not made from a wireless device (S104: NO), the process returns to S103 again, and detection of whether the earphones are worn is performed.

In the case where connection is made from a wireless device (S104: YES), the earphones operate as wireless earphones that output a sound based on audio information from the wireless device, with the noise cancellation function or the sound collection function remaining turned on (S105).

As described above, according to the first embodiment, the wireless function of the listening apparatus 10 can be automatically turned off without an additional operation being performed by a user. Accordingly, consumption of the power source unit 15 can be reduced. Furthermore, because the wireless function is turned off, it is possible to avoid a risk of connection by a third party. Moreover, in the pairing mode, if a pairing destination is not found and a predetermined period of time is elapsed, power of the listening apparatus 10 is possibly turned off. In this case, if the configuration of the first embodiment is applied, the power is not turned off even after a lapse of the predetermined period of time, and it is possible to use only the noise cancellation function and the sound collection function.

### Second Embodiment

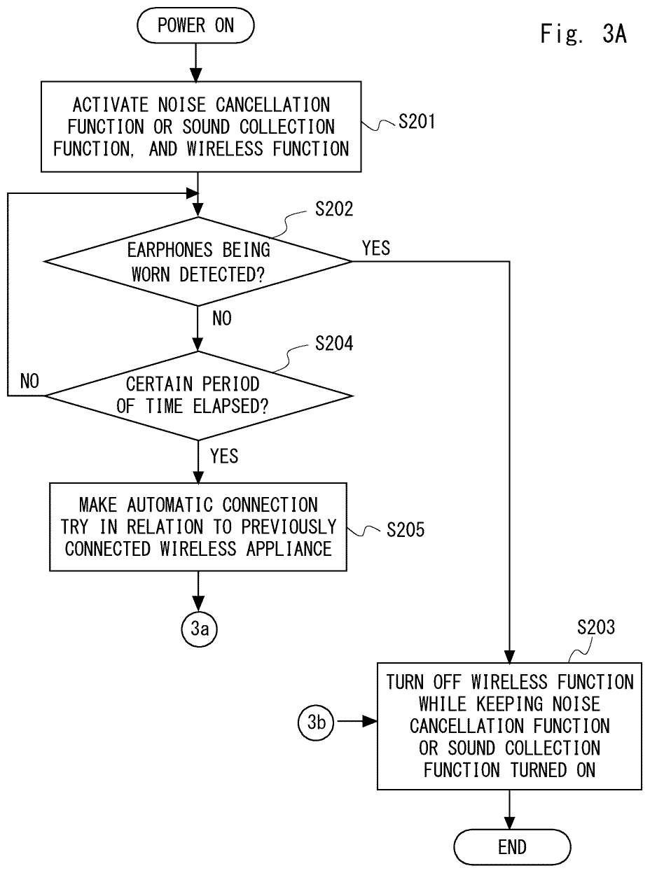

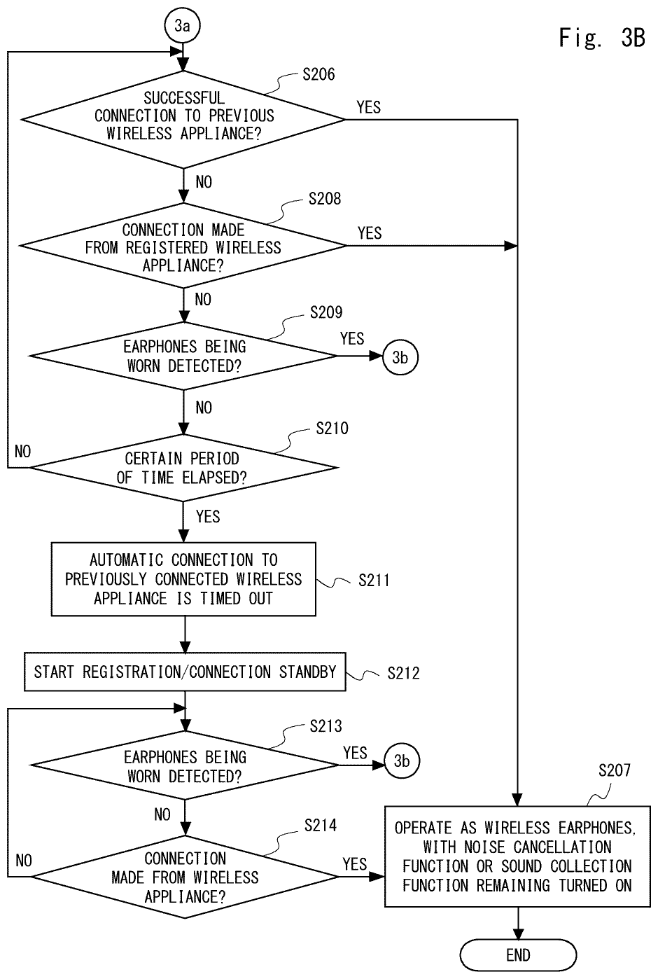

FIGS. 3A and 3B are flowcharts for describing a control method of a listening apparatus according to a second embodiment. Like the first embodiment, the second embodiment is an example of a control method of left-right integrated wireless earphones. The flowcharts in FIGS. 3A and 3B indicate an example where on/off of the wireless function is controlled when the earphones are to perform reconnection to a registered wireless device. The flowcharts in FIGS. 3A and 3B show three processes, namely, (1) reconnection preprocessing, (2) reconnection process for registered wireless device, and (3) connection standby process for unregistered wireless device.

### (1) Reconnection Preprocessing

As shown in FIG. 3A, when the power of the earphones is turned on, the noise cancellation function or the sound collection function, and the wireless function are activated (S201). Then, whether it is detected or not that the earphones are worn is determined (S202). In the case where it is detected that the earphones are worn (S202: YES), the control processing unit 23 turns off the wireless function while keeping the noise cancellation function or the sound collection function turned on (S203).

On the other hand, in the case where it is not detected that the earphones are worn (S202: NO), whether a certain period of time is elapsed or not is determined (S204). In the case where the certain period of time is not elapsed (S204: NO), the process returns to S202 again. At this time, the wireless function is in an on state, but a connection try is not made in relation to a registered wireless device. After the certain period of time is elapsed (S204: YES), an automatic connection try is made in relation to a previously connected wireless device (S205), and S206 in FIG. 3B is performed next.

### (2) Reconnection Process for Registered Wireless Device

In S206, whether connection to a previous wireless device succeeded or not is determined. In the case of successful connection (S206: YES), the earphones operate as wireless earphones that output a sound based on audio information from the wireless device, with the noise cancellation function or the sound collection function remaining turned on (S207). In the case of connection failure (S206: NO), whether or not connection is successfully made from a registered wireless device other than the previously connected wireless device is determined (S208).

Successful connection of a registered wireless device other than the previously connected wireless device means that the registered wireless device is operated, a reconnection request is transmitted to the listening apparatus 10, and a communicable state is reached, for example. Also in the case of successful connection in S208 (YES), the earphones operate as wireless earphones that output a sound based on audio information from the wireless device, with the noise cancellation function or the sound collection function remaining turned on (S207).

In the case of connection failure in S208 (NO), whether it is detected or not that the earphones are worn is determined (S209). In the case where it is detected that the earphones are worn (S209: YES), the control processing unit 23 turns off the wireless function while keeping the noise cancellation function or the sound collection function turned on (S203).

On the other hand, in the case where it is not detected that the earphones are worn (S209: NO), whether a certain period of time is elapsed or not is determined (S210). In the case where the certain period of time is not elapsed (S210: NO), the process returns to S206 again. When the certain period of time is elapsed (S210: YES), automatic connection from the earphones to the previously connected wireless device is timed out (S211), and a transition to a registration/connection standby process for an unregistered wireless device is made (S212).

### (3) Connection Standby Process for Unregistered Wireless Device

In S212, registration/connection standby is started for an unregistered wireless device. Then, whether it is detected or not that the earphones are worn is determined (S213). In the case where it is detected that the earphones are worn (S213: YES), the control processing unit 23 turns off the wireless function while keeping the noise cancellation function or the sound collection function turned on (S203). On the other hand, in the case where it is not detected that the earphones are worn (S213: NO), whether connection is made from a wireless device or not is determined (S214). In the case where connection is not made from a wireless device (S214: NO), the process returns to S213 again, and detection of whether the earphones are worn is performed.

In the case where connection is made from a wireless device (S214: YES), the earphones operate as wireless earphones that output a sound based on audio information from the wireless device, with the noise cancellation function or the sound collection function remaining turned on (S207).

In a specific example of an operation of the earphones, for five seconds after the power is turned on, the earphones only perform detection of whether the earphones are worn without searching for a registered wireless device. For ten seconds after a lapse of five seconds, the earphones repeatedly perform determination of whether it is detected that the earphones are worn before connection from a wireless device is performed, while repeatedly making a connection try in relation to a registered device. After a lapse of ten seconds, the earphones stop the connection retry, and can repeatedly perform determination of whether it is detected that the earphones are worn before connection from a wireless device is performed, while staying in registration standby and connection standby for an unregistered wireless device.

As described above, according to the second embodiment, as in the first embodiment, the wireless function of the listening apparatus 10 can be automatically turned off without an additional operation being performed by a user. Furthermore, even when a pairing destination is not found, it is possible to use only the noise cancellation function and the sound collection function. Furthermore, detection of whether the earphones are worn is performed immediately after the power is turned on, and use of the sound collection function or the noise cancellation function is enabled, and it is not necessary to wait for a connection process for a wireless device that is automatically performed at the time of activation of the listening apparatus 10.

### Third Embodiment

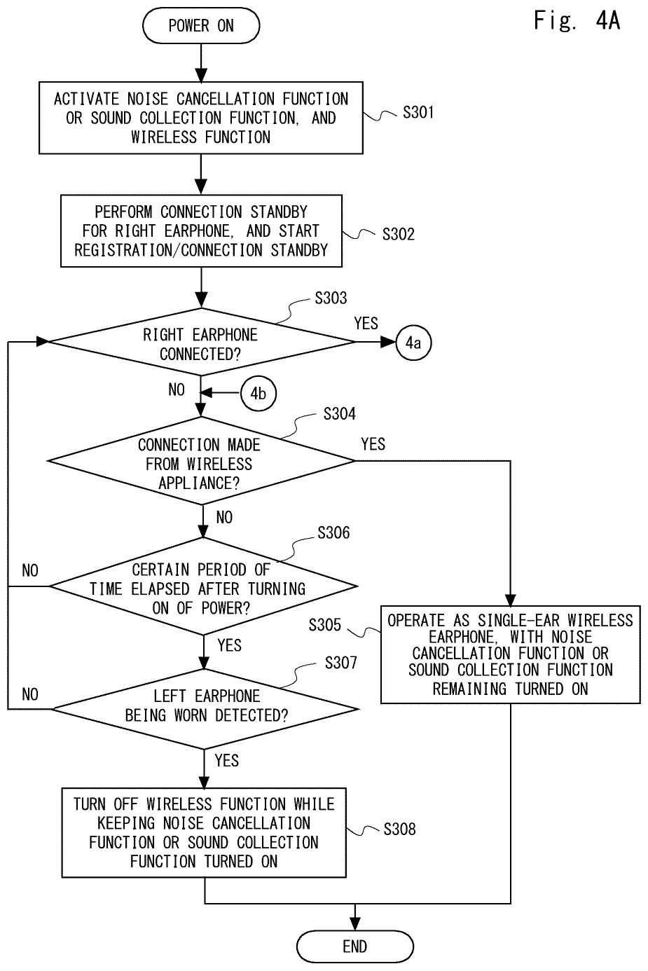

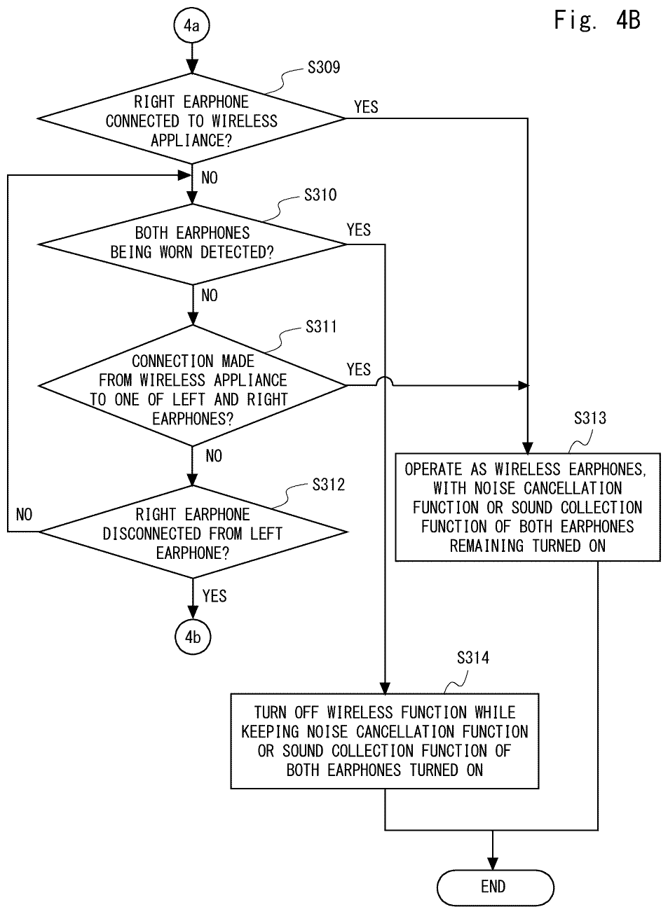

FIGS. 4A and 4B are flowcharts for describing a control method of a listening apparatus according to a third embodiment. The third embodiment is an example of a control method of left-right separated wireless earphones. Of the left-right separated earphones, one that is worn on the right ear of a user will be referred to as a right earphone, and one that is worn on the left ear will be referred to as a left earphone. The right earphone and the left earphone can be used as two-ear earphones in a state where both earphones are connected, or can each be used as a single-ear earphone. The right earphone and the left earphone each include the structural elements shown in FIG. 1. The flowcharts in FIGS. 4A and 4B indicate an example where the earphone controls on/off of the wireless function when in a pairing mode in which registration standby is performed in relation to an unregistered wireless device. In FIGS. 4A and 4B, processes related to the left earphone are shown, but processes such as connection to a wireless device and detection of worn earphone are performed in the same manner also in relation to the right earphone.

As shown in FIG. 4A, when power of the left earphone is turned on, the noise cancellation function or the sound collection function, and the wireless function are activated (S301). The left earphone performs connection standby for the right earphone, and also starts registration/connection standby for an unregistered wireless device (S302). In the case where the left earphone is connected to the right earphone (S303: YES), a transition to the steps shown in FIG. 4B takes place.

On the other hand, in the case where the left earphone is not connected to the right earphone (S303: NO), processes are performed assuming use of only the left earphone. First, whether connection is made from a wireless device to the left earphone or not is determined (S304). In the case where connection is made from a wireless device (S304: YES), the left earphone operates as a single-ear wireless earphone that outputs a sound based on audio information from the wireless device, with the noise cancellation function or the sound collection function remaining turned on (S305).

In the case where connection is not made from a wireless device in the left earphone (S304: NO), whether a certain period of time from turning on of power is elapsed or not is determined (S306). The reason why standby until a lapse of a certain period of time is performed as in S306 after the power is turned on and the wireless function is activated is because, when the wireless function is turned off, the left earphone and the right earphone cannot be connected. In the case where the certain period of time is not elapsed after turning on of power, the process returns to S303 again. Furthermore, in the case where the certain period of time is elapsed after turning on of power, whether it is detected whether the left earphone is worn or not is determined (S307).

In the case where it is detected that the left earphone is worn (S307: YES), the wireless function of the left earphone is turned off, with the noise cancellation function or the sound collection function remaining turned on (S308). The left earphone thus operates as a single-ear earphone including only the noise cancellation function or the sound collection function. On the other hand, in the case where it is not detected that the left earphone is worn (S307: NO), the process returns to S303 again.

Next, a case where the left earphone is connected to the right earphone (S303: YES) will be described. As shown in FIG. 4B, first, whether the right earphone is already connected to a wireless device or not is determined (S309). In the case where the right earphone is connected to a wireless device (S309: YES), the earphones operate as two-ear wireless earphones, with the noise cancellation function or the sound collection function of both earphones remaining turned on (S313).

In the case where the right earphone is not connected to a wireless device (S309: NO), whether it is detected or not that both earphones are worn is determined (S310). For example, the ear-worn detection unit 11 of each earphone transmits a detection signal to the other earphone after detecting wearing by the user, so that it is possible to determine that both earphones are worn. In the case where it is detected that both earphones are worn (S310: YES), the wireless function is turned off while the noise cancellation function or the sound collection function of both earphones remains turned on (S314). In the case where it is not detected that both earphones are worn (S310: NO), whether connection is made from a wireless device to one of the left and right earphones is determined (S311). In the case where connection is made from a wireless device to one of the left and right earphones (S311: YES), S313 is performed next, and the earphones operate as two-ear wireless earphones, with the noise cancellation function or the sound collection function of both earphones remaining turned on.

In the case where connection is not made from a wireless device in either of the left and right earphones (S311: NO), whether the right earphone is disconnected from the left earphone or not is determined (S312). In the case where the right earphone is not disconnected from the left earphone (S312: NO), the process returns to S310 again, and subsequent steps are repeated. Furthermore, in the case where the right earphone is disconnected from the left earphone (S312: YES), S304 in FIG. 4A is performed, and subsequent processes are performed assuming use of only the left earphone.

As described above, according to the third embodiment, also with the left-right separated listening apparatus 10, the wireless function of the listening apparatus 10 can be automatically turned off without the user performing an additional operation. Furthermore, if even one of the left and right earphones is confirmed to have been worn by the user before connection to a wireless device, the wireless function may be turned off, and it is possible to use only the noise cancellation function or the sound collection function.

Additionally, the listening apparatus 10 may further include a notification unit for notifying of information indicating whether the wireless function is on or off. The notification unit may be a display unit that notifies of the information using texts, or a light emission unit, such as an LED, that issues a notification through light emission. Furthermore, the user may be notified of information indicating on or off of the wireless function of the listening apparatus 10, through audio from the audio output unit 13. The user may thus check whether the listening apparatus 10 is in an intended state (for example, a state of being used as a sound collector where only the wireless function is turned off and only the sound collection function is turned on, a state of being used as wireless earphones where all the functions including the wireless function are turned on, or the like).

In the case where the listening apparatus 10 is placed in a state that is not intended by the user, various settings of the listening apparatus 10 can be changed as described below.

In a first example, in a case where connection to a wireless device is to be made after the listening apparatus 10 being worn is detected and the wireless function is turned off, the power can be turned off and then turned on again to turn on the wireless function. As described above, power of the listening apparatus 10 can be turned off by operation of an operation button, for example. Furthermore, the wireless function can be switched on by operation of an operation button provided on the listening apparatus 10.

In a second example, in a case where, even though the wireless function is desired to be turned off, connection to a wireless device is completed before the user wears the listening apparatus 10, connection between the listening apparatus 10 and the wireless device can be disconnected. The wireless function of the listening apparatus 10 can be automatically turned off when a certain period of time is elapsed in a disconnected state. The listening apparatus 10 and the wireless device may be disconnected through operation of the wireless device or by performing a certain button operation on the listening apparatus 10. Alternatively, an automatic connection function of automatically searching for a registered wireless device when power is turned on may be turned off so that connection to a wireless device can be manually performed through a certain button operation on the listening apparatus 10.

In a third example, in a case where pairing is not possible because the listening apparatus 10 is worn by the user even though the user wants to establish pairing with a wireless device without turning off the wireless function, a function of turning off the wireless function may be disabled by a certain button operation on the listening apparatus 10. Furthermore, on/off of a function of automatically turning off the wireless function of the listening apparatus 10 may be set by activating an application program installed in a smartphone that is capable of connecting to the listening apparatus 10 by using the wireless function.

It is also possibly to partially turn off the wireless function. In a case where it is possible to remotely operate the listening apparatus 10 by an application program installed in a smartphone that is capable of connecting to the listening apparatus 10 by using the wireless function, if the wireless function is completely turned off, operation cannot be performed remotely and it is inconvenient. Accordingly, it is possible to turn off one or some functions without completely turning off the wireless function. For example, in a case where the listening apparatus 10 supports both Bluetooth Classic and Bluetooth Low Energy (BLE) of Bluetooth 4.0 standards as the wireless function, it is possible to turn off Bluetooth Classic for transmitting music and the like, and to turn on only BLE as a communication channel for remote operation. This allows power to be saved, and a remote control function to be used.

Moreover, it is also possible to turn off the pairing mode (a registration standby state for an unregistered wireless device) without turning off Bluetooth Classic. In this case, because the listening apparatus 10 is not connected to a wireless device, power can be saved, and also, a risk of being connected by an unregistered third party can be avoided. In this case, manual connection to the listening apparatus 10 can be achieved any time by operating a registered wireless device. In the following, in relation to the wireless function of the listening apparatus 10, an example will be described where registration standby is discontinued and connection standby is continued.

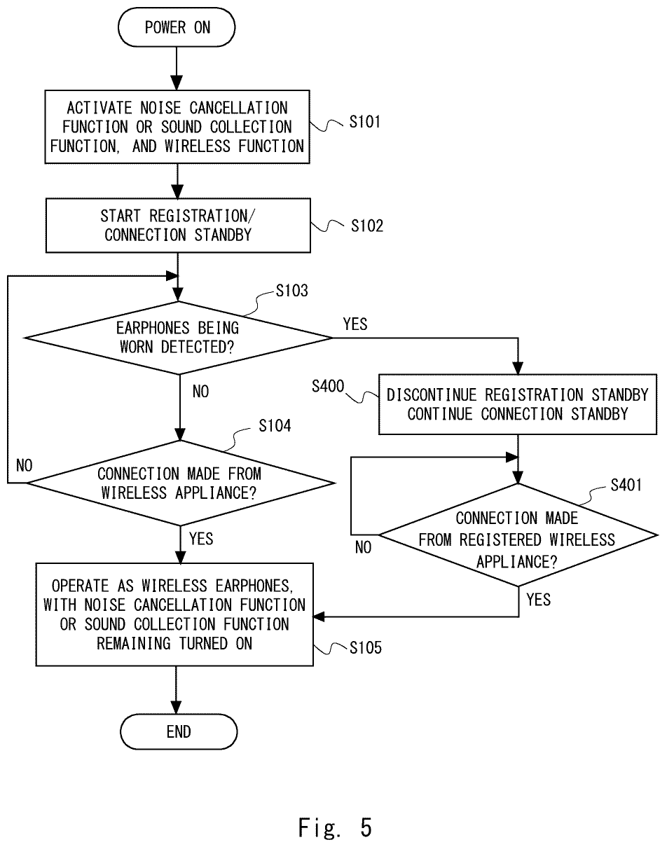

FIG. 5 is a flowchart for describing a modified example of the control method of the listening apparatus according to the first embodiment. In FIG. 5, steps the same as those in FIG. 2 are denoted by the same reference signs, and description thereof is omitted as appropriate. In the example shown in FIG. 5, steps S400 and S401 are provided instead of S106 in FIG. 2. In the case where it is detected that the earphones are worn by the user in S103 (YES), registration standby is discontinued, and connection standby is continued (S400). Then, in the case where connection is made from a registered wireless device (S401: YES), the listening apparatus 10 can be caused to operate as wireless earphones, with the noise cancellation function or the sound collection function remaining turned on (S105).

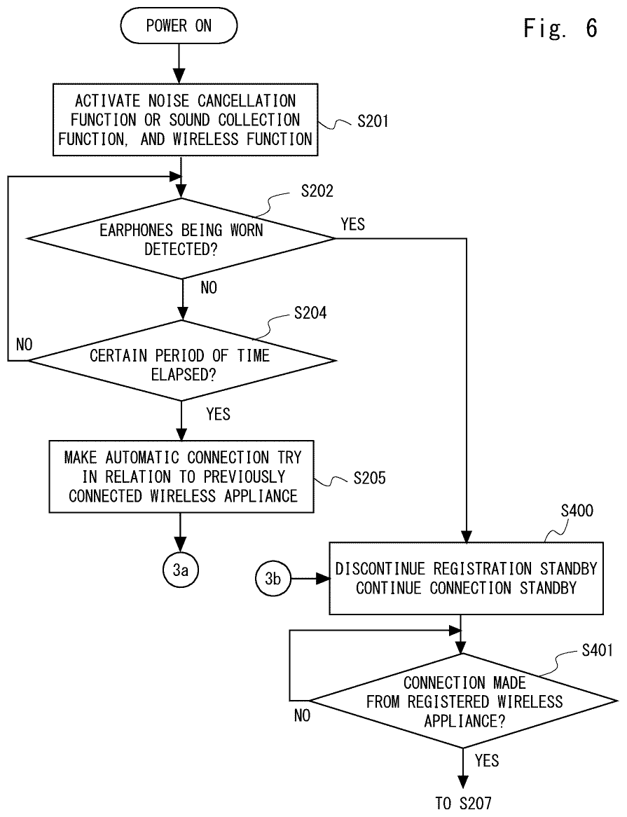

FIG. 6 is a flowchart for describing a modified example of the control method of the listening apparatus according to the second embodiment. FIG. 6 corresponds to FIG. 3A in the second embodiment. In FIG. 6, steps the same as those in FIG. 3A are denoted by the same reference signs, and description thereof is omitted as appropriate. Steps in FIG. 6 that are changed (S400, S401) are the same as the steps in FIG. 5 that are changed. In the case where it is detected that the earphones are worn by the user in S202 (YES), registration standby is discontinued, and connection standby is continued (S400), and in the case where connection is made from a registered wireless device (S401: YES), the listening apparatus 10 can be caused to operate as wireless earphones, with the noise cancellation function or the sound collection function remaining turned on (S207).

The listening apparatus 10 according to the embodiments is assumed to be used in a situation where only the noise cancellation function and the sound collection function of the listening apparatus 10 are used outside a range where a wireless device can be connected. Furthermore, in the case where the listening apparatus 10 is to be used as a sound collector, a situation is assumed where, after personal setting is initially performed according to hearing ability of the user by an application program installed in a smartphone, the application program is not activated and only the listening apparatus 10 is used.

As described above, according to the embodiments, with the listening apparatus 10 including the noise cancellation function and the sound collection function (ambient sound capturing function), upon wearing on the ear of a user during wireless device connection standby, the wireless earphone function can be automatically turned off while keeping only the noise cancellation function and the sound collection function turned on. Accordingly, consumption of the power source unit 15 can be suppressed, and endurance period of the power source unit 15 can be increased. Moreover, erroneous connection of another wireless device can be avoided.

Heretofore, the invention made by the present inventors have been specifically described with reference to the embodiments, but the present invention is not limited to the embodiments described above, and various changes can, of course, be made within the scope of the invention.

According to the present disclosure, on/off of the wireless function of the listening apparatus can be automatically controlled.

The above embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A listening apparatus of a type worn on an ear, including at least one of a noise cancelling processing unit and a collected sound processing unit, the listening apparatus comprising:
a wireless communication unit configured to be connected to a wireless device, the wireless communication unit being capable of receiving an audio signal from the wireless device;
an ear-worn detection unit configured to detect whether the listening apparatus is worn on an ear or not; and
a control processing unit configured to turn off the wireless communication unit in a case where it is detected that the listening apparatus is worn on an ear before the wireless communication unit is connected to the wireless device.

2. The listening apparatus according to claim 1, wherein, in a case where it is detected that the listening apparatus is worn on an ear before the wireless communication unit is connected to the wireless device, the control processing unit places at least one of the noise cancelling processing unit and the collected sound processing unit in an on state.

3. The listening apparatus according to claim 1, wherein, among a plurality of functions of the wireless communication unit, the control processing unit discontinues a registration standby function for an unregistered wireless device and places at least one function in an on state, in a case where it is detected that the listening apparatus is worn on an ear before the wireless communication unit is connected to the wireless device.

4. The listening apparatus according to claim 1, wherein the control processing unit turns off at least one function among a plurality of functions of the wireless communication unit.

5. The listening apparatus according to claim 1, wherein the ear-worn detection unit is a sensor that automatically detects that the listening apparatus is worn on an ear.

6. A control method of a listening apparatus that is of a type worn on an ear and that includes at least one of a noise cancelling processing unit and a collected sound processing unit, the control method comprising:
a step of connecting a wireless communication unit of the listening apparatus to a wireless device so that an audio signal from the wireless device can be received;
a step of detecting whether the listening apparatus is worn on an ear or not; and
a step of turning off the wireless communication unit in a case where it is detected that the listening apparatus is worn on an ear before the listening apparatus is connected to the wireless device.

7. A non-transitory computer readable medium storing program for causing a computer to execute:
a process of connecting a wireless communication unit of a listening apparatus that is of a type worn on an ear and that includes at least one of a noise cancelling processing unit and a collected sound processing unit, to a wireless device so that an audio signal from the wireless device can be received,
a process of detecting whether the listening apparatus is worn on an ear or not, and
a process of turning off the wireless communication unit in a case where it is detected that the listening apparatus is worn on an ear before the listening apparatus is connected to the wireless device.
